(19) United States
(12) Patent Application Publication
(10) Pub. No.: US 2011/0181844 A1
(43) Pub. Date: Jul. 28, 2011

(54) PROJECTION DISPLAY DEVICE

(75) Inventors: Yuji HASHIBA, Kizugawa-city (JP); Yusuke YAMAMOTO, Osaka (JP); Toshihiro SARUWATARI, Osaka (JP)

(73) Assignee: SANYO ELECTRIC CO., LTD., Osaka (JP)

(21) Appl. No.: 13/014,609

(22) Filed: Jan. 26, 2011

(30) Foreign Application Priority Data
Jan. 27, 2010 (JP) 2010-015209

(51) Int. Cl. G03B 21/16

(52) U.S. Cl. 353/52

(57) ABSTRACT

A projection display device includes a main body cabinet; a shield member which is disposed in the main body cabinet, and shields an electromagnetic wave; an air inlet which is formed in the main body cabinet; and a filter device which removes unwanted matters from an air drawn into the main body cabinet through the air inlet. In this arrangement, the filter device includes a metal filter. The metal filter and the shield member are electrically connected to each other when the filter device is mounted in the main body cabinet.

This application claims priority under 35 U.S.C. Section 119 of Japanese Patent Application No. 2010-15209 filed Jan. 27, 2010, entitled “PROJECTION DISPLAY DEVICE”. The disclosure of the above application is incorporated herein by reference.

### BACKGROUND OF THE INVENTION

1. Field of the Invention

The present invention relates to a projection display device for enlarging and projecting light modulated by an imager onto a projection plane.

2. Disclosure of Related Art

In a projection display device (hereinafter, called as a “projector”), light modulated by an imager such as a liquid crystal panel is projected onto a projection plane through a projection lens. In the projector, heat is generated in a power source unit or a light source. In view of this, the projector is provided with an arrangement for releasing the heat generated in the projector to the outside of the projector. Specifically, a main body cabinet is formed with an air inlet for drawing in the external air, and an air outlet for discharging the air inside the main body cabinet. The air drawn in through the air inlet is passed around heat generating parts, and then, discharged through the air outlet. With this operation, the heat inside the main body cabinet is removed.

Further, the projector is provided with a shield member for shielding an electromagnetic wave generated in the main body cabinet. The electromagnetic wave generated in the main body cabinet is likely to be transmitted to the outside through the air inlet and the air outlet. In view of this, it is desirable to provide a shield member as well as for the air inlet and the air outlet.

Normally, however, a filter device for removing unwanted matters from the drawn-in air is mounted in the air inlet. In this arrangement, it is not easy to dispose the shield member in the air inlet. An air inlet is originally provided to draw in the air. Accordingly, in the case where a shield member is disposed in the air inlet, air passing means such as an opening is formed in the shield member not to block an air flow. Forming the opening as described above, however, may likely cause transmission of an electromagnetic wave to the outside of the main body cabinet through the opening, which may lower the shield effect.

### SUMMARY OF THE INVENTION

A projection display device according to a main aspect of the invention includes a main body cabinet; a shield member which is disposed in the main body cabinet, and shields an electromagnetic wave; an air inlet which is formed in the main body cabinet; and a filter device which removes unwanted matters from an air drawn into the main body cabinet through the air inlet. In this arrangement, the filter device includes a metal filter. The metal filter and the shield member are electrically connected to each other when the filter device is mounted in the main body cabinet. For instance, the projection display device is provided with a contact portion which is formed on the shield member, and contacts with the metal filter when the filter device is mounted in the main body cabinet.

### BRIEF DESCRIPTION OF THE DRAWINGS

These and other objects, and novel features of the present invention will become more apparent upon reading the following detailed description of the embodiment along with the accompanying drawings.

FIGS. 1A and 1B are perspective views showing an external arrangement of a projector embodying the invention.

FIG. 2 is a perspective view showing an internal arrangement of the projector as the embodiment.

FIG. 3 is a diagram showing arrangements of an optical engine and a projection lens unit in the embodiment.

FIGS. 4A and 4B are perspective views of the projector in the embodiment respectively showing a state that a rear cover is detached, and a state that a filter unit and the rear cover are detached.

FIG. 5 is a perspective view of an upper cabinet in the embodiment, when viewed from a bottom side of the upper cabinet.

FIGS. 6A and 6B are diagrams showing an arrangement of the filter unit in the embodiment.

FIG. 7 is a cross-sectional view of essential parts showing a state that the filter unit is mounted in an air inlet portion in the embodiment.

The drawings are provided mainly for describing the present invention, and do not limit the scope of the present invention.

### DESCRIPTION OF PREFERRED EMBODIMENTS

In the following, an embodiment of the invention is described referring to the drawings.

In this embodiment, a shield plate 13 corresponds to a shield member and a first shield member in the claims. Projections 131 correspond to a contact portion in the claims. A shield plate 14 corresponds to a shield member and a second shield member in the claims. Projections 141 correspond to a contact portion in the claims. A filter unit 90 corresponds to a filter device in the claims. A first filter 91 corresponds to a metal filter in the claims. The description regarding the correspondence between the claims and the embodiment is merely an example, and the claims are not limited by the description of the embodiment.

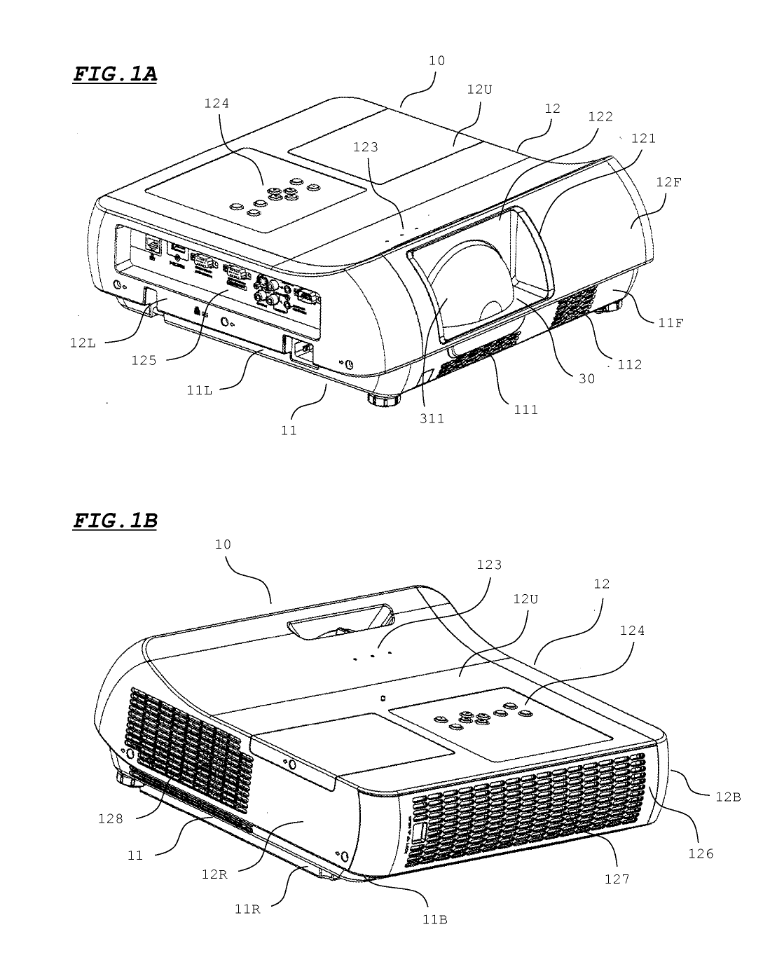

FIGS. 1A and 1B are perspective views showing an external arrangement of a projector. FIG. 1A is a perspective view of the projector when viewed from a front side thereof, and FIG. 1B is a perspective view of the projector when viewed from a rear side thereof.

Referring to FIGS. 1A and 1B, the projector is provided with a main body cabinet 10. The main body cabinet 10 is constituted of a lower cabinet 11, and an upper cabinet 12 to be covered onto the lower cabinet 11 from above.

The lower cabinet 11 has a box-like shape with a small height, and an upper surface thereof is opened. The lower cabinet 11 is configured in such a manner that a front surface 11F is higher than a left side surface 11L, a right side surface 11R, and a back surface 11B. The left side surface 11L and the right side surface 11R are configured in such a manner that front ends thereof gradually rise, and are continued to the front surface 11F.

The front surface 11F of the lower cabinet 11 is formed with an air inlet 111. The air inlet 111 is constituted of multitudes of slit holes. The front surface 11F of the lower cabinet 11 is further formed with a sound output port 112. Sounds in accordance with images are outputted through the sound output port 112 at the time of image projection.

The upper cabinet 12 has a box-like shape, and a lower surface thereof is opened. A front portion of the upper cabinet 12 is gradually curved upward over the entirety in left and right directions, and a front surface 12F thereof is directed slightly obliquely upward. The front surface 12F of the upper cabinet 12 is gradually curved when viewed from a lateral direction thereof, and is protruded obliquely upward from the front surface 11F of the lower cabinet 11.

The front surface 12F of the upper cabinet 12 is formed with a rectangular projection port 121 at a position closer to the left side surface of the upper cabinet 12 with respect to the center thereof. A housing portion 122 for housing a lens 311 corresponding to a front end of a projection lens unit 30 is formed at a rear position of the projection port 121.

An upper surface 12U of the upper cabinet 12 is formed with an indicator portion 123 and an operation portion 124. A certain number of LEDs are provided on the indicator portion 123. The user is allowed to confirm whether the projector is in an operating state or a standby state by on/off states of the respective LEDs. The user is also allowed to confirm various error states. A certain number of operation keys are provided on the operation portion 124.

An AV terminal portion 125 is provided on the left side surface 12L of the upper cabinet 12, and various AV terminals are exposed on the left side surface 12L of the upper cabinet 12. AV (Audio Visual) signals are inputted and outputted to and from the projector via the AV terminal portion 125.

The back surface 1213 of the upper cabinet 12 is constituted of a detachable rear cover 126. The rear cover 126 is formed with an air inlet 127. The air inlet 127 is constituted of multitudes of slit holes. The right side surface 12R of the upper cabinet 12 is formed with an air outlet 128. The air outlet 128 is constituted of multitudes of slit holes. The external air drawn into the main body cabinet 10 through the air inlet 127 and the air inlet 111 of the lower cabinet 11 is discharged through the air outlet 128 after cooling heat generating parts disposed in the main body cabinet 10, such as liquid crystal panels and a light source lamp.

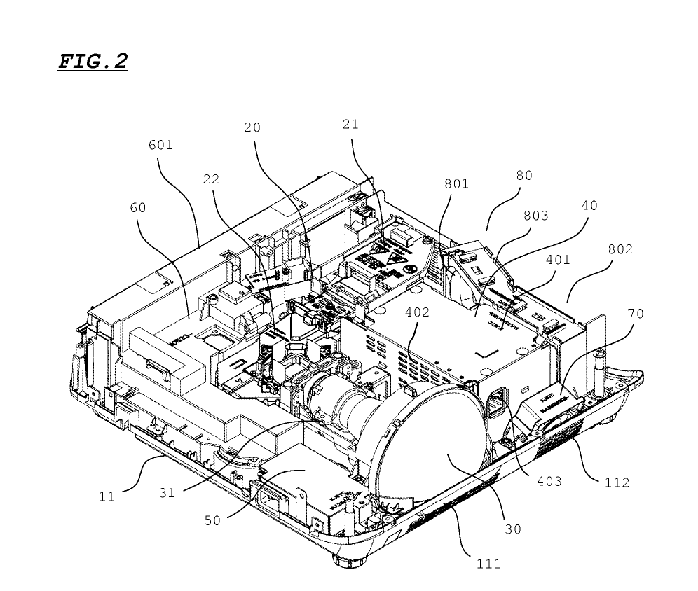

FIG. 2 is a perspective view showing an internal arrangement of the projector.

As shown in FIG. 2, the lower cabinet 11 is internally provided with an optical engine 20, the projection lens unit 30, a main power source unit 40, a sub power source unit 50, a cooling unit 60, a speaker 70, and an exhaust fan unit 80. Although other members such as a control circuit unit are disposed in the lower cabinet 11, illustration thereof is omitted in FIG. 2.

The optical engine 20 is provided with a light source portion 21 having a light source lamp, and an optical system 22 for modulating light from the light source portion 21 to generate image light. The optical engine 20 is disposed slightly rearward with respect to the center of the lower cabinet 11. The projection lens unit 30 is disposed in front of the optical system 22 of the optical engine 20, and slightly leftward with respect to the center of the lower cabinet 11. The projection lens unit 30 is fixed to the lower cabinet 11 via a lens holder 31.

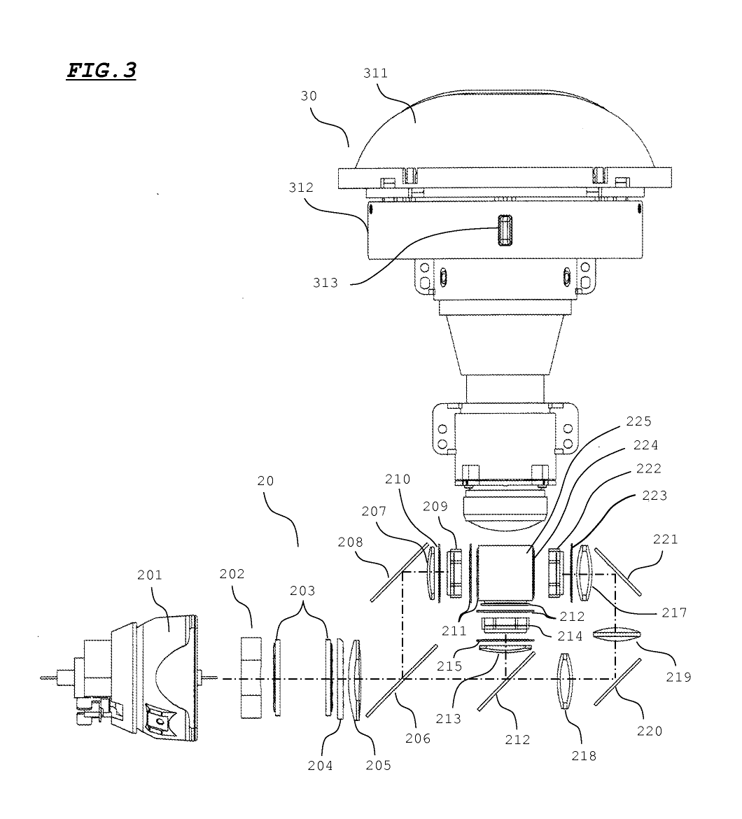

FIG. 3 is a diagram showing an arrangement of the optical engine 20 and the projection lens unit 30.

White light emitted from the light source lamp 201 is transmitted through a condenser lens 202, a fly-eye integrator 203, and a PBS array 204. The fly-eye integrator 203 is adapted to make the light amount distributions of light of the each of the colors to be irradiated onto liquid crystal panels (which will be described later) uniform, and the PBS array 204 is adapted to align polarization directions of light directed toward a dichroic mirror 206 in one direction.

Light transmitted through the PBS array 204 is transmitted through a condenser lens 205, and is entered into the dichroic mirror 206.

The dichroic mirror 206 reflects only light (hereinafter, called as “B light”) in a blue wavelength band, and transmits light (hereinafter, called as “G light”) in a green wavelength band and light (hereinafter, called as “R light”) in a red wavelength band, out of the light entered into the dichroic mirror 206.

B light reflected on the dichroic mirror 206 is irradiated onto a liquid crystal panel 209 for B light in a proper irradiation state by a lens function of the condenser lens 205 and a condenser lens 207, and reflection on a reflection mirror 208. The liquid crystal panel 209 is driven in accordance with an image signal for B light to modulate the B light depending on a driven state of the liquid crystal panel 209. One incident-side polarizer 210 is disposed on the incident side of the liquid crystal panel 209. B light is irradiated onto the liquid crystal panel 209 through the incident-side polarizer 210. Further, two output-side polarizers 211 are disposed on the output side of the liquid crystal panel 209, and B light emitted from the liquid crystal panel 209 is entered into the output-side polarizers 211.

G light and R light transmitted through the dichroic mirror 206 are entered into a dichroic mirror 212. The dichroic mirror 212 reflects the G light and transmits the R light.

G light reflected on the dichroic mirror 212 is irradiated onto a liquid crystal panel 214 for G light in a proper irradiation state by a lens function of the condenser lens 205 and a condenser lens 213. The liquid crystal panel 214 is driven in accordance with an image signal for G light to modulate the G light depending on a driven state of the liquid crystal panel 214. One incident-side polarizer 215 is disposed on the incident side of the liquid crystal panel 214, and G light is irradiated onto the liquid crystal panel 214 through the incident-side polarizer 215. Further, two output-side polarizers 216 are disposed on the output side of the liquid crystal panel 214, and G light emitted from the liquid crystal panel 214 is entered into the output-side polarizers 216.

R light transmitted through the dichroic mirror 212 is irradiated onto a liquid crystal panel 222 for R light in a proper irradiation state by a lens function of the condenser lens 205, 217, and relay lenses 218 and 219, and reflection on reflection mirrors 220 and 221. The liquid crystal panel 222 is driven in accordance with an image signal for R light to modulate the R light depending on a driven state of the liquid crystal panel 222. One incident-side polarizer 223 is disposed on the incident side of the liquid crystal panel 222, and R light is irradiated onto the liquid crystal panel 222 through the incident-side polarizer 223. Further, one output-side polarizer 224 is disposed on the output side of the liquid crystal panel 222, and R light emitted from the liquid crystal panel 222 is entered into the output-side polarizer 224.

B light, G light, and R light modulated by the liquid crystal panels 209, 214, and 222 are transmitted through the output-side polarizers 211, 216, and 224, and entered into a dichroic prism 225. The dichroic prism 225 reflects B light and R light, and transmits G light, out of the B light, the G light, and the R light, to thereby combine the B light, the G light, and the R light. Thus, image light after the color combination is projected toward the projection lens unit 30 from the dichroic prism 225.

The projection lens unit 30 is provided with a certain number of lenses, and is adapted to enlarge and project the entered image light onto a screen. The projection lens unit 30 is configured as a short focal length type, and a large sized lens 311 is included at a front end of the projection lens unit 30. Image light is emitted slightly obliquely upward from the lens 311.

The projection lens unit 30 is further provided with a focus ring 312. The focus ring 312 is formed with a focus lever 313. When the focus lever 313 is operated, the focus ring 312 is pivotally moved, and a focus lens (not shown) disposed in the projection lens unit 30 is moved in association with the focus ring 312. Thus, by operating the focus lever 313, focus for a projected image is adjusted.

Referring back to FIG. 2, the main power source unit 40 is disposed on the right side of the projection lens unit 30, and the sub power source unit 50 is disposed on the left side of the projection lens unit 30. The main power source unit 40 is provided with a power source circuit within a housing 401, and is adapted to supply an electric power to the respective electrical components of the projector. The housing 401 is formed with a vent 402 constituted of multitudes of holes on a side surface thereof on the side of the projection lens unit 30. Another vent (not shown) is formed on the opposite side surface of the housing 401.

The sub power source unit 50 is provided with a noise filter and a smoothing circuit, and is adapted to remove noises from an AC power provided from a commercial power source. The sub power source unit 50 supplies the noise removed AC power to the main power source unit 40.

The cooling unit 60 is disposed behind the optical engine 20. The cooling unit 60 is provided with an air intake fan (not shown). An air inlet portion 601 of the cooling unit 60 is formed at a rear end of the lower cabinet 11. The cooling unit 60 supplies the external air drawn in through the air inlet portion 601 from the rear side of the main body cabinet 10 to the main heat generating parts of the optical engine 20 such as the liquid crystal panels 209, 214, and 222 to thereby cool the heat generating parts.

The speaker 70 is disposed in front of the main power source unit 40. Sounds outputted from the speaker 70 are released to the outside through the sound output port 112.

The exhaust fan unit 80 is disposed on the right side of the main power source unit 40, and at a right side end of the lower cabinet 11. The exhaust fan unit 80 is constituted of a first exhaust fan 801, a second exhaust fan 802, and a fan holder 803 for fixedly holding the first exhaust fan 801 and the second exhaust fan 802 to the lower cabinet 11.

The first exhaust fan 801 has an air in-take surface thereof being tilted slightly obliquely rearward with respect to the left side surface of the main body cabinet 10. The first exhaust fan 801 is adapted to discharge to the outside an air that has been warmed by cooling the heat generating parts (such as the liquid crystal panels 209, 214, and 222; and the light source lamp 201) inside the optical engine 20. The first exhaust fan 801 is also adapted to discharge to the outside an air that has been drawn in through the air inlet 111 and warmed by cooling the projection lens unit 30.

The second exhaust fan 802 has an air in-take surface thereof being directed to the main power source unit 40. The second exhaust fan 802 discharges to the outside an air that has been warmed by cooling the main power source unit 40.

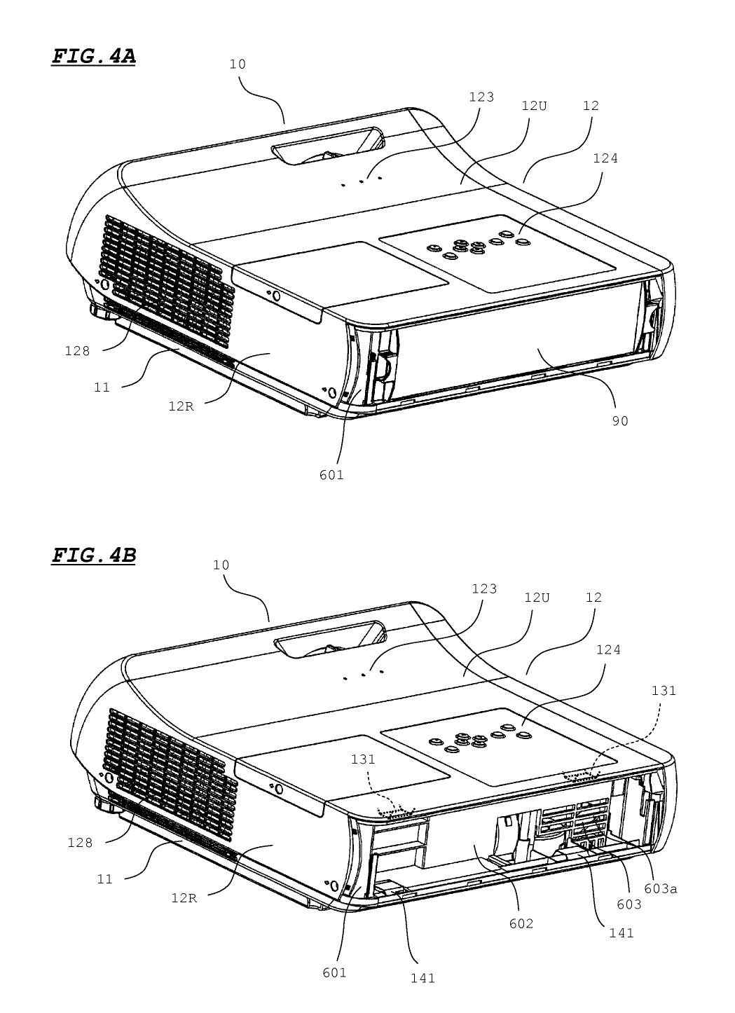

FIG. 4A is a perspective view of the projector showing a state that the rear cover 126 is detached.

As shown in FIG. 4A, a detachable filter unit 90 is disposed in the air inlet portion 601 of the cooling unit 60. As will be described later, the filter unit 90 has three filters having different mesh sizes to stepwise remove the dusts or fumes drawn in through the air inlet 127 by the corresponding filters depending on the sizes.

FIG. 4B is a perspective view of the projector showing a state that the rear cover 126 and the filter unit 90 are detached.

As shown in FIG. 4B, the air inlet portion 601 has a housing portion 602 for housing the filter unit 90 therein. A rear wall of the housing portion 602 is formed with an air inlet 603 communicating with the interior of the cooling unit 60. A grid portion 603a is formed in the air inlet 603. An external air from which dusts and the like are removed by the filter unit 90 is drawn into the cooling unit 60 through the air inlet 603.

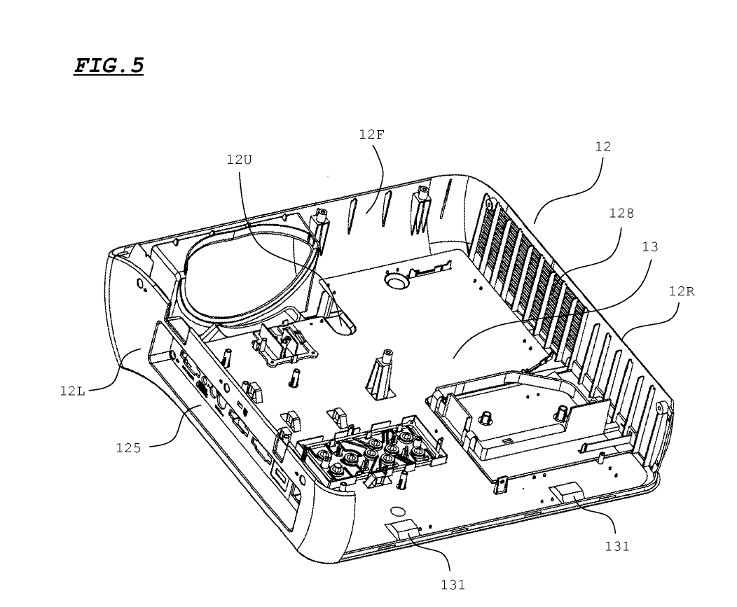

FIG. 5 is a perspective view of the upper cabinet 12 when viewed from a bottom side of the upper cabinet 12.

As shown in FIG. 5, a metallic shield plate 13 is mounted on the back of the upper surface 12U of the upper cabinet 12. The shield plate 13 is connected to a ground wire included in a power cord to be connected to a commercial power source. When the power cord is connected to the commercial power source, the shield plate 13 is grounded through the ground wire. The shield plate 13 shields an electromagnetic wave which has been generated in the electronic components inside the main body cabinet 10 and is about to leak to the outside of the main body cabinet 10. The shield plate 13 also blocks an external electromagnetic wave from intruding into the main body cabinet 10.

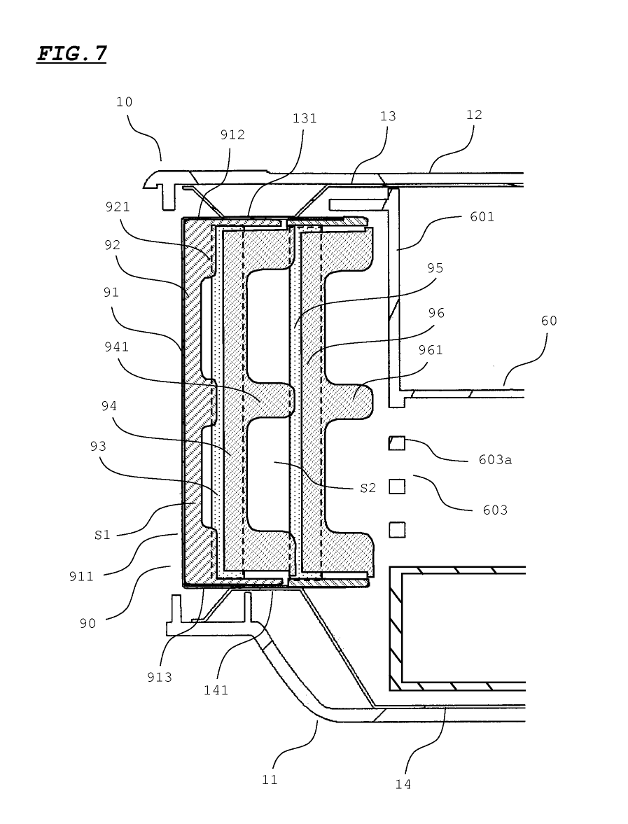

Two projections 131 having a trapezoidal shape in cross section are formed on a rear end of the shield plate 13. As shown in FIG. 4B, the two projections 131 protrude into the housing portion 602 in a state that the upper cabinet 12 and the lower cabinet 11 are assembled to each other (see FIG. 7).

Similarly to the upper cabinet 12, a shield plate 14 (see FIG. 7) is mounted on an inner bottom surface of the lower cabinet 11. Similarly to the upper cabinet 12, the shield plate 14 is connected to a ground wire included in a power cord to be connected to a commercial power source, and blocks an electromagnetic wave which is about to leak out of the main body cabinet 10, or an external electromagnetic wave which is about to intrude into the main body cabinet 10. Similarly to the upper cabinet 12, two projections 141 having a trapezoidal shape in cross section are formed on a rear end of the shield plate 14, and as shown in FIG. 4B, the two projections 141 also protrude into the housing portion 602.

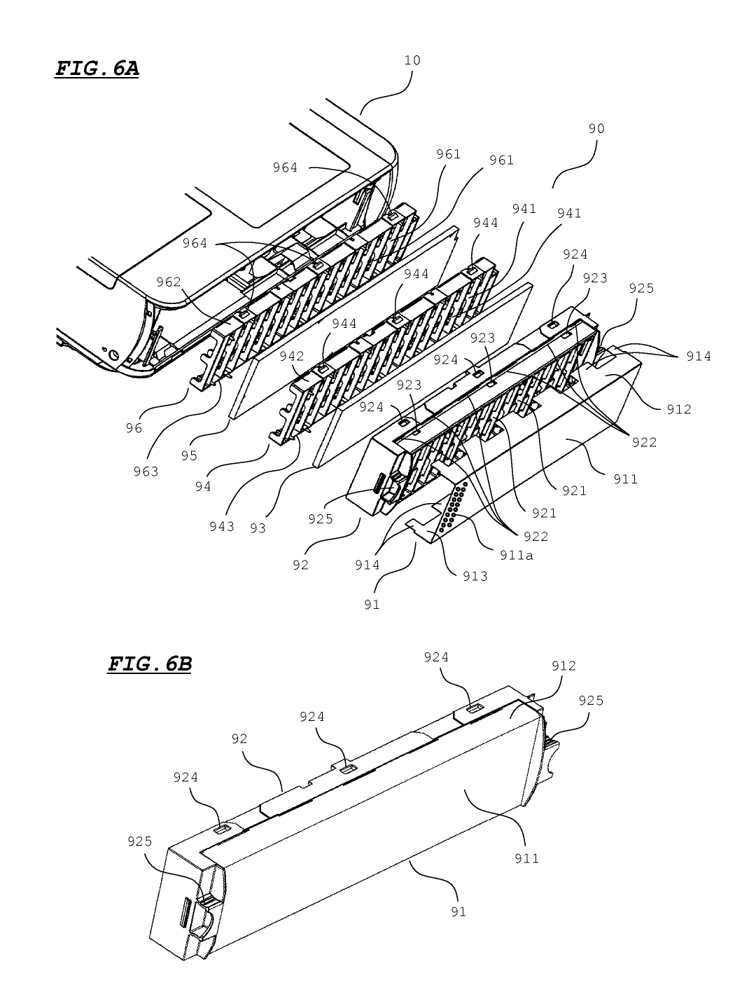

FIGS. 6A and 6B are diagrams showing an arrangement of the filter unit 90. FIG. 6A is an exploded perspective view of the filter unit 90, and FIG. 6B is a perspective view showing a state that a first filter 91 and a filter case 92 are assembled into one unit. In FIG. 6A, only a part of punch holes 911a of the first filter 91 is shown; and in FIG. 6B, illustration of the punch holes 911a is omitted.

Referring to FIGS. 6A and 6B, the filter unit 90 is constituted of the first filter 91, the filter case 92, a second filter 93, a first support member 94, a third filter 95, and a second support member 96.

The first filter 91 is produced by processing a metal plate such as an iron plate. The first filter 91 is constituted of a rectangular front plate 911, and an upper plate 912 and a lower plate 913 each extending rearward from an upper end and a lower end of the front plate 911.

Multitudes of the punch holes 911a are formed generally over the entire surface of the front plate 911. The size of each punch hole 911a is e.g. from about 1 mm to about 2 mm. Six insertion portions 914 are formed on each of the rear end of the upper plate 912 and the rear end of the lower plate 913. The first filter 91 is configured to have the largest mesh size among the three filters.

The filter case 92 is a rectangular parallelepiped container with a front surface and a rear surface thereof being opened. A certain number of vertically extending ribs 921 are formed in a grid manner in the front surface opening. Each of the ribs 921 is cut away at a portion between an upper end and a middle portion thereof from the rear side, and is also cut away at a portion between the middle portion and a lower end thereof from the rear side. In other words, each of the ribs 921 has an E-shape.

Six slit holes 922 are formed in each of the upper surface and the lower surface of the filter case 92 for receiving the insertion portions 914 of the first filter 91. Further, three first engaging holes 923 and three second engaging holes 924 are formed in each of the upper surface and the lower surface of the filter case 92. Further, the front surface of the filter case 92 is formed with handle portions 925 at left and right ends thereof. The user is allowed to hold the handle portions 925 in mounting the filter unit 90 in the housing portion 602. FIG. 6A shows only the slit holes 922, the first engaging holes 923, and the second engaging holes 924 in the upper surface of the filter case 92.

As shown in FIG. 6B, the first filter 91 is fixed to the front surface of the filter case 92. With this arrangement, the first filter 91 and the filter case 92 are assembled into one unit. In the assembling operation, the insertion portions 914 of the first filter 91 are inserted into the slit holes 922 of the filter case 92, and bent forward. Thus, the second filter 93, the first support member 94, the third filter 95, and the second support member 96 are housed into the filter case 92 fixedly mounted with the first filter 91 from the rear side.

Both of the second filter 93 and the third filter 95 are formed into a rectangular filter made of polyurethane. The second filter 93 has a smaller mesh size than the first filter 91, and the third filter 95 has a smaller mesh size than the second filter 93.

The first support member 94 has a ladder shape, wherein vertically extending ribs 941 disposed with a predetermined interval are connected to each other by an upper plate 942 and a lower plate 943. Each of the ribs 941 is cut away at a portion between an upper end and a middle portion thereof from the rear side, and is also cut away at a portion between the middle portion and a lower end thereof from the rear side. In other words, each of the ribs 941 has an E-shape. Each of the upper plate 942 and the lower plate 943 is formed with three claw portions 944. When the first support member 94 is housed in the filter case 92, the respective claw portions 944 are engaged in the corresponding first engaging holes 923. With this operation, the first support member 94 is held in the filter case 92.

The second support member 96 has the same shape as the first support member 94, and has a ladder shape, wherein vertically extending ribs 961 disposed with a predetermined interval are connected to each other by an upper plate 962 and a lower plate 963. Similarly to the ribs 941, each of the ribs 961 has an E-shape. Similarly to the first support member 94, each of the upper plate 962 and the lower plate 963 is formed with three claw portions 964. When the second support member 96 is housed in the filter case 92, the claw portions 964 are engaged in the corresponding second engaging holes 924. With this operation, the second support member 96 is held in the filter case 92.

FIG. 7 is a cross-sectional view of essential parts showing a state that the filter unit 90 is mounted in the air inlet portion 601.

The second filter 93 is held in the filter case 92 while being interposed between rear ends of the each rib 921 of the filter case 92, and a front end of the first support member 94. As shown by the broken line in FIG. 7, the second filter 93 has a thickness larger than the interval between the ribs 921 and the ribs 941, and a portion of the second filter 93 corresponding to the ribs 921 and 941 is pressed and deformed by the ribs 921 and 941.

The third filter 95 is held in the filter case 92 while being interposed between rear ends of the each rib 941 of the first support member 94, and a front end of the second support member 96. As shown by the broken line in FIG. 7, the third filter 95 has a thickness larger than the interval between the ribs 941 and the ribs 961, and a portion of the third filter 94 corresponding to the ribs 941 and 961 is pressed and deformed by the ribs 941 and 961.

When the air in-take fan in the cooling unit 60 is driven, the external air is drawn in through the air inlet portion 601. The drawn-in air is at first passed through the first filter 91. Dusts and the like in the external air, whose size is larger than the size of meshes (punch holes 911a) of the first filter 91 are removed by the first filter 91. The external air that has passed through the first filter 91 is passed through the second filter 93 and the third filter 95 in this order, and dusts and the like, whose size is larger than the sizes of meshes of the second filter 93 and the third filter 95 are removed by the second filter 93 and the third filter 95. In this way, the external air whose dusts and the like are removed by the three filters 91, 93, and 95 is drawn into the cooling unit 60 through the air inlet portion 603.

In this arrangement, a certain clearance S1 is secured between the first filter 91 and the second filter 93 by the each rib 921 of the filter case 92. Further, a certain clearance S2 is secured between the second filter 93 and the third filter 95 by the each rib 941 of the first support member 94.

In the case where an anterior filter and a posterior filter are firmly contacted with each other, if the anterior filter is partially clogged, an air does not flow through a portion of the posterior filter at a position immediately behind the clogged portion of the anterior filter. This makes it impossible to remove the dusts and the like by the portion of the posterior filter, despite that the portion of the posterior filter is not clogged.

In this embodiment, since the clearances S1 and S2 are defined between the first filter 91 and the second filter 93, and between the second filter 93 and the third filter 95, even if a portion of the anterior filter is clogged, an air is allowed to flow sufficiently onto a portion of the posterior filter at a position immediately behind the clogged portion of the anterior filter. This enables to remove the dusts and the like by the portion of the posterior filter. Thus, it is possible to sufficiently function the posterior filter.

Further, each of the ribs 921 and 941 is formed with a cutaway portion to thereby reduce a contact area of the ribs 921 and 941 with respect to front surfaces of the second filter 93 and the third filter 95. This enables to reduce a filter portion which may be deprived of the function because of being covered by the ribs 921 and 941, and to suppress lowering of the function of the second filter 93 and the third filter 95.

When the filter unit 90 is mounted in the air inlet portion 601, the upper plate 912 of the first filter 91 is contacted with the two projections 131 of the shield plate 13, and the lower plate 913 is contacted with the two projections 141 of the shield plate 14. With this operation, the first filter 91 is electrically connected to the shield plates 13 and 14, and are grounded via the shield plates 13 and 14. Thus, the first filter 91 is operable to shield an electromagnetic wave that is about to leak to the outside or about to intrude from the outside from the rear surface side (a region corresponding to the air inlet portion 127) of the main body cabinet 10.

As described above, in the embodiment, the first filter 91 is configured to be a metal filter, and the first filter 91 is brought into contact with the other shield members (shield plates 13 and 14) inside the main body cabinet 10, it is possible to shield an electromagnetic wave that is about to leak out of the main body cabinet 10 or about to intrude into the main body cabinet 10 from the rear surface side of the main body cabinet 10, without additionally providing a shield member in the air inlet portion 601. This enables to reduce the cost and the number of parts for countermeasures against EMC (Electro-Magnetic Compatibility).

Further, the first filter 91 has a sufficiently small mesh size for removing large-sized dusts or the like. Accordingly, using the first filter 91 both as a member for removing large-sized dusts, and as a shield member enables to obtain an enhanced shield effect with a simplified construction.

Further, in this embodiment, the interior of the main body cabinet 10 is surrounded by shield members. Specifically, since the interior of the main body cabinet 10 is surrounded by the shield plates 13 and 14, and the first filter 91, the arrangement is more advantageous in suppressing leakage of an electromagnetic wave.

Furthermore, in this embodiment, the filter unit 90 is constituted of plural filters in such a manner that the mesh size is increased as the filter is disposed at an outer position, and that the first filter 91 to be disposed at the outermost position is a metal filter. This enables to stepwise remove unwanted matters of different sizes. Further, in the above arrangement, there is no need of making the mesh size of the filter too small, and the first filter 91 made of a metal can be realized with a simplified construction by e.g. forming multitudes of holes (punch holes) in a filter surface. Thus, the above arrangement is advantageous in reducing the production cost.

The embodiment of the invention has been described as above. The invention, however, is not limited to the foregoing embodiment, and the embodiment of the invention may be modified in various ways other than the above.

For instance, in the embodiment, the filter unit 90 is constituted of a metal filter (first filter 91), and other two filters (second filter 93 and third filter 95). Alternatively, the filter unit 90 may be constituted of a metal filter and other one filter, or constituted of a metal filter and other three or more filters.

Further, in the embodiment, the first filter 91 is configured to be contacted with both of the shield plate 13 on the upper surface side of the main body cabinet 10 and the shield plate 14 on the bottom surface side of the main body cabinet 10. Alternatively, the first filter 91 may be configured to be contacted with one of the shield plates 13 and 14. The arrangement of the embodiment that the first filter 91 is contacted with both of the shield plates 13 and 14 is more advantageous in shielding an electromagnetic wave. Further, in the case where a shield member is disposed on a side other than the upper surface side or the lower surface side of the main body cabinet 10, the first filter 91 may be configured to be contacted with the shield member.

Furthermore, in the embodiment, the filter surface of the first filter 91 is constructed by forming multitudes of the punch holes 911a in the front plate 911. The construction of the metal filter is not limited to the above. For instance, the first filter 91 may be configured to be a metal filter having a filter surface made of a wire mesh. Further alternatively, the other filters (second filter 93 and third filter 95) are not limited to a filter made of polyurethane, but may be a filter made of nonwoven fabric, for instance.

Furthermore, in the embodiment, the air inlet 127 and the filter unit 90 corresponding to the air inlet 127 are disposed on the rear surface side of the main body cabinet 10. Alternatively, for instance, the air inlet 127 and the filter unit 90 may be disposed on either one of the left side surface and the right side surface of the main body cabinet 10.

Moreover, in the embodiment, the two projections 131 and the two projections 141 are formed on the shield plates 13 and 14, respectively. Alternatively, the number of the projections 131, 141 is not limited to two. As far as the first filter 91 is properly contacted with the shield plates 13 and 14, the number of the projections 131, 141 may be one. It is, however, desirable to provide a plural number of the projections 131, 141 to more securely contact the first filter 91 with the shield plates 13 and 14.

The embodiment of the invention may be changed or modified in various ways as necessary, as far as such changes and modifications do not depart from the scope of the claims of the invention hereinafter defined.

What is claimed is:

1. A projection display device comprising:
a main body cabinet;
a shield member which is disposed in the main body cabinet, and shields an electromagnetic wave;
an air inlet which is formed in the main body cabinet; and
a filter device which removes unwanted matters from an air drawn into the main body cabinet through the air inlet, wherein
the filter device includes a metal filter, and
the metal filter and the shield member are electrically connected to each other when the filter device is mounted in the main body cabinet.

2. The projection display device according to claim 1, further comprising
a contact portion which is formed on the shield member, and contacts with the metal filter when the filter device is mounted in the main body cabinet.

3. The projection display device according to claim 2, wherein
the shield member includes a first shield member and a second shield member which are respectively provided on an upper surface and a bottom surface of the main body cabinet, and
each of the first shield member and the second shield member is formed with the contact portion.

4. The projection display device according to claim 1, wherein
the filter device includes a plurality of filters having different mesh sizes from each other, and the mesh size is increased, as the filter is disposed at an outer position.

5. The projection display device according to claim 4, wherein
the filter disposed at an outermost position of the plurality of the filters is the metal filter.

6. The projection display device according to claim 1, wherein
the filter device includes a plurality of filters disposed in an airflow direction, and
a clearance is defined between the adjacent two filters.
